(19) United States
(12) Patent Application Publication
(10) Pub. No.: US 2021/0280969 A1
(43) Pub. Date: Sep. 9, 2021

(54) TIME SYNCHRONIZATION METHOD, DEVICE AND SYSTEM, AND STORAGE MEDIUM

(71) Applicant: SZ DJI TECHNOLOGY CO., LTD., Shenzhen (CN)

(72) Inventors: Zebin FANG, Shenzhen (CN); Hongshi TAN, Shenzhen (CN); Wenxin HU, Shenzhen (CN)

(21) Appl. No.: 17/326,316

(22) Filed: May 20, 2021

Related U.S. Application Data
(63) Continuation of application No. PCT/CN2018/116791, filed on Nov. 21, 2018.

(51) Int. Cl. H01Q 3/04; H01Q 1/42; H01Q 1/32; H02P 21/18

(52) U.S. Cl. CPC H01Q 3/04; H02P 21/18; H01Q 1/3233; H01Q 1/42

(57) ABSTRACT

The present disclosure provides a time synchronization method, device and system, and a storage medium. The time synchronization system includes a first part and a second part, that are mechanically connected, movable relative to each other, and in a wireless communication connection. The method includes the second part receiving the first time axis information and the first movement parameter sent by the first part, the first movement parameter corresponding to the first time axis information for indicating a movement relationship between the first part and the second part; the second part determining the second time axis information corresponding to the first movement parameter in the local second time axis; and the second part adjusting the second time axis based on the first time axis information and the second time axis information, such that the second time axis is synchronized with the first time axis.

### CROSS-REFERENCE TO RELATED APPLICATION

This application is a continuation of International Application No. PCT/CN2018/116791, filed Nov. 21, 2018, the entire content of which is incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of data processing technology and, more specifically, to a time synchronization method, device and system, and a storage medium.

### BACKGROUND

Generally, there are at least two modules in a large electronic system, and each module can perform work and data processing based on its own clock system. Therefore, if the clocks between the modules in the same system cannot be synchronized, it may cause security ricks due to time desynchronization.

At present, for two independent modules in the same system, if there is a relative movement of the two modules, they can only rely on wireless communication for data synchronization. However, due to the large delay in wireless communication, in conventional technology, the delay is generally estimated multiple time and an average value is taken as the communication delay between two independent modules. As such, the time between two independent modules can be synchronized based on the communication delay.

However, the communication delay can change dynamically in real time. As the time and/or environment change, the communication delay estimated by the method described in conventional technology can have a large deviation, which leads to the issue of poor synchronization accuracy in the time synchronization performed thereby.

### SUMMARY

Embodiments of the present disclosure provide a time synchronization method, device and system, and a storage medium to solve the issue of poor accuracy of time synchronization between independent modules in conventional technology.

In one aspect, the present disclosure provides a time synchronization method including a time synchronization system including a first part and a second part, the first part being mechanically connected to the second part, the first part being movable relative to the second part, and the first part being connected to the second part through a wireless communication. The method includes the second part receiving first time axis information and a first movement parameter sent by the first part, the first movement parameter corresponding to the first time axis information for indicating a movement relationship between the first part and the second part; the second part determining second time axis information corresponding to the first movement parameter in a local second time axis; and the second part adjusting the second time axis based on the first time axis information and the second time axis information such that the second time axis is synchronized with the first time axis.

In another aspect, the present disclosure provides a time synchronization method including a time synchronization system including a first part and a second part, the first part being mechanically connected to the second part, the first part being movable relative to the second part, and the first part being connected to the second part through a wireless communication. The method includes the first part obtaining first time axis information; the first part obtaining a first movement parameter, the first movement parameter corresponding to the first time axis information for indicating a movement relationship between the first part and the second part; and the first part sending the first time axis information and the first movement parameter to the second part through wireless communication.

In another aspect, the present disclosure provides a time synchronization device including a time synchronization system including a first part and a second part, the first part being mechanically connected to the second part, the first part being movable relative to the second part, and the first part being connected to the second part through wireless communication. The device is disposed on the second part, including a wireless communication device configured to receive first time axis information and a first movement parameter sent by the first part, the first movement parameter corresponding to the first time axis information for indicating a movement relationship between the first part and the second part; and a processor configured to determine second time axis information corresponding to the first movement parameter in a local second time axis, the processor being configured to adjust the second time axis based on the first time axis information and the second time axis information such that the second time axis is synchronized with the first time axis.

In another aspect, the present disclosure provides a time synchronization device including a time synchronization system including a first part and a second part, the first part being mechanically connected to the second part, the first part being movable relative to the second part, and the first part being connected to the second part through wireless communication. The device is disposed on the first part, including a processor configured to obtain first time axis information and a first movement parameter the first movement parameter corresponding to the first time axis information for indicating a movement relationship between the first part and the second part; and a wireless communication device configured to send the first time axis information and the first movement parameter to the second part through wireless communication.

In another aspect, the present disclosure provides a time synchronization system including a first part provided with the disclosed time synchronization devices; and a second part provided with the disclosed time synchronization devices.

In another aspect, the present disclosure provided a non-transitory computer-readable storage medium having a computer program stored thereon, and the computer program can be executed by a controller to implement the disclosed methods.

In another aspect, the present disclosure provided a non-transitory computer-readable storage medium having a computer program stored thereon, and the computer program can be executed by a controller to implement the disclosed methods.

In the technical solutions provided by the present disclosure, the first part and the second part can move relative to each other. Therefore, when the relative movement of the first part and the second part reaches the same physical position, the movement parameters can have a fixed difference, and the time when the first part and the second part move to the same physical position can also be the same. Using this as the basis for time consistency, the second time axis of the second part can be adjusted to synchronize the time axes of the first part and the second part. In this process, the estimated communication delay is not used as the basis for time synchronization. Even if there is a communication delay between the two, time synchronization can be realized based on the aforementioned time consistency, which can avoid the delay issues of wireless communication. In addition, this time synchronization method can be adjusted and calibrated in real time. Compared with the conventional time synchronization method, the deviation of the time synchronization is smaller and the synchronization accuracy is higher.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1A is a schematic structural diagram of a time synchronization system according to an embodiment of the present disclosure.

FIG. 1B is a schematic structural diagram of another time synchronization system according to an embodiment of the present disclosure.

FIG. 2 is a schematic diagram of an interaction process of a time synchronization method according to an embodiment of the present disclosure.

FIG. 3 is a flowchart of another time synchronization method according to an embodiment of the present disclosure.

FIG. 4 is a flowchart of another time synchronization method according to an embodiment of the present disclosure.

FIG. 5 is a flowchart of another time synchronization method according to an embodiment of the present disclosure.

FIG. 6 is a schematic diagram of the interaction process of another time synchronization method according to an embodiment of the present disclosure.

FIG. 7 is a functional block diagram of a time synchronization device according to an embodiment of the present disclosure.

FIG. 8 is a schematic diagram of a physical structure of the time synchronization device according to an embodiment of the present disclosure.

FIG. 9 is a schematic structural diagram another time synchronization system according to an embodiment of the present disclosure.

Specific embodiments of the present disclosure are shown by the above drawings, and more detailed description will be made hereinafter. These drawings and text description are not for limiting the scope of conceiving the present disclosure in any way, but for illustrating the concept of the present disclosure for those skilled in the art by referring to specific embodiments.

### DETAILED DESCRIPTION OF THE EMBODIMENTS

Here the illustrative embodiments will be described in detail, examples of which are shown in the accompanying drawings. In the following descriptions, when the accompanying drawings are involved, unless there are other express indication, the same numbers in different accompanying drawings indicate the same or similar elements. The implementation methods described in the following illustrative embodiments do not represent all implementation methods consistent with the present disclosure. Conversely, they are only examples of the device and method that are consistent with some aspects of the present disclosure that are described in the accompanying claims.

A specific application scenario of the present disclosure may be an intra-system time synchronization scenario with at least two independent parts. In this time synchronization scenario, the parts may be mechanically connected and may move relative to each other, and the parts may communicate wireless.

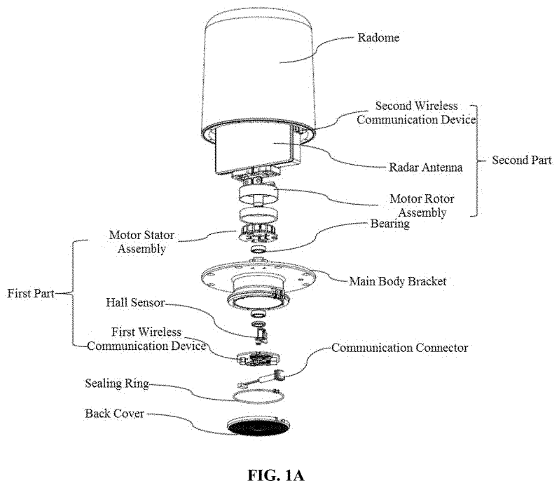

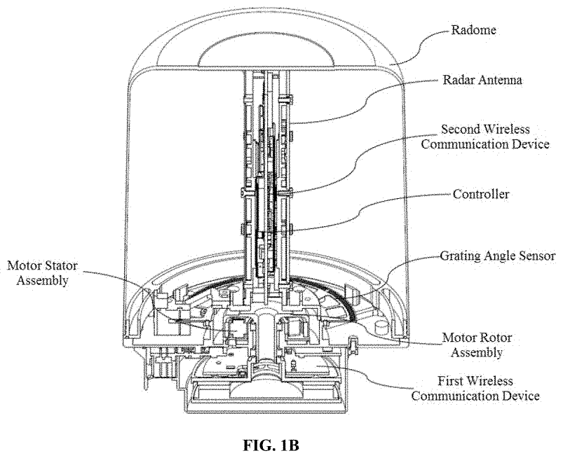

For example, in a specific implementation scenario, the scenario may be as shown in FIG. 1A and FIG. 1B. In this scenario, the time synchronization system is a rotating radar system. The rotating radar system includes a stator part and a rotor part that are mechanically connected, and can rotate relative to each other and communicate wirelessly. In this implementation scenario, the time synchronization method provided in the present disclosure can be used to achieve time synchronization between the stator part and the rotor part.

In the illustrated embodiment, the rotating radar system includes a radome, a main body bracket, a back cover, a first wireless communication device, a second wireless communication device, a motor rotor, a motor stator, a first angle sensor, a second angle sensor, and a radar antenna.

In some embodiments, the radome may be fixedly connected to one side of the main body bracket to form a first receiving space. The back cover may be fixedly connected with the other side of the main body bracket to form a second receiving space. The first receiving space may be connected to the second receiving space.

The radar antenna may be disposed in the first receiving space. The radar antenna may be fixedly connected with the motor rotor, and driven to rotate by the motor rotor.

A communication connector may be used for a wired communication connection between the rotating radar system and an external device. The first wireless communication device may be used to establish a wireless communication connection with the second wireless communication device. The second wireless communication device may be electrically connected with the radar antenna.

The first angle sensor may be used to sensor the rotation angle of the motor. For example, the first angle sensor may be a Hall sensor. The second angle sensor may be used to sense the rotation angle of the radar antenna. For example, the second angle sensor may be a grating angle sensor. In some embodiments, since the radar antenna can rotate with the motor rotor, the rotation angle of the radar antenna may be equal to the rotation angle of the motor.

In some embodiments, the rotor part (i.e., the second part) may include the radar antenna, an electronic rotor assembly, and a second wireless communication device. The stator part (i.e., the first part) may include a motor stator assembly and the first wireless communication device. The rotor part may rotate relative to the stator part.

The time synchronization function may be performed by a controller of the radar, a controller of the second wireless communication device, a controller of the first wireless communication device, or other independent controllers. These controllers may include one or more processors that cooperate with each other.

In addition, the present disclosure may also include other application scenarios, such as the time synchronization scenarios between a system with at least two independent parts and an external device. In some embodiments, the parts in the system may be mechanically connected and capable of relative movement, and the parts may communicate wirelessly. The external device may realize the wired communication with one of the parts in the system through a connection line interface.

For example, the time synchronization system may be a gimbal system. The gimbal system may include a stator part and a rotor part that may be mechanically connected, and may rotate relative to each other and communicate wirelessly. In this implementation scenario, the time synchronization method provided in the present disclosure can be used to achieve time synchronization between the stator part and the rotor part.

For example, in another implementation scenario, the time synchronization system between the rotating radar system and the external control device may be as shown in FIG. 1A and FIG. 1B, where the external control device can be connected with the stator part in the rotating radar system through the connection interface. In this implementation scenario, the external control device and the stator part can be time synchronized through the connection interface, and the stator part and the rotor part can be time synchronized through the time synchronization method provided in the present disclosure.

It should be understood that the above rotating radar system is merely an example for the application scenarios of the technical solutions, and it not used to limit the relative movement relationship between the first part and the second part in the technical solutions.

The technical solutions of the present disclosure and how the technical solutions of the present disclosure can solve the above technical issues will be described in detail below with specific embodiments. The following specific embodiments can be combined with each other, and the same or similar concepts or processes may not be repeated in some embodiments. The embodiments of the present disclosure will be described below in conjunction with the drawings.

### First Embodiment

An embodiment of the present disclosure provides a time synchronization method. The method may be applied to a time synchronization system, and the time synchronization system may include a first part and a second part. The first part and the second part may be mechanically connected, the first part and the second part may move relative to each other, and the first part and the second part may be connected in a wireless communication.

It should be noted that in the embodiments of the present disclosure, there is no specific limitation on the respective numbers of the first part and the second part in the time synchronization system. In a specific implementation, the specific structure of the time synchronization system will prevail. For any two parts (or devices, systems, etc.) in the time synchronization system that meet the foregoing relationship between the first part and the second part, the method adopted in the embodiments of the present disclosure can be used to achieve time synchronization.

Next, for ease of description, the first part and the second part are taken as an example to superficially describe the time synchronization method provided in the embodiments of the present disclosure.

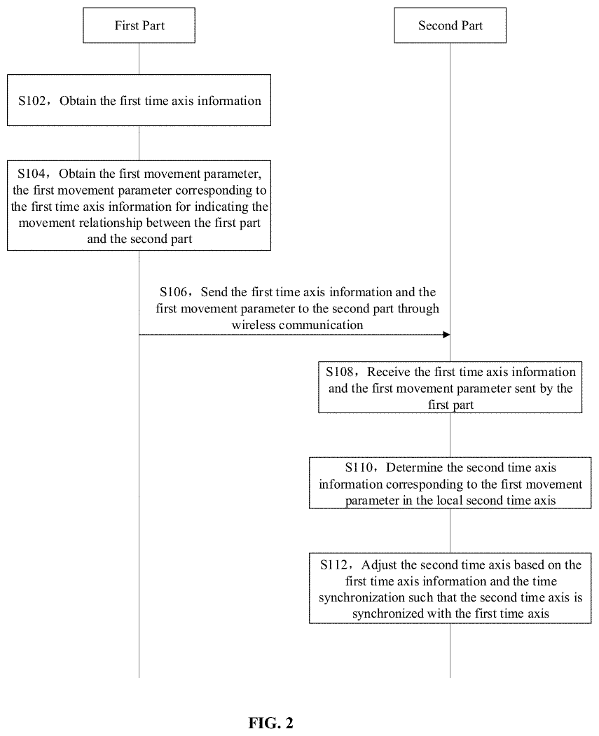

More specifically, an embodiment of the present disclosure provides a schematic diagram of an interaction process between the first part and the second part. Referring to FIG. 2, the method includes the following processes.

S102, the first part obtains first time axis information.

S104, the first part obtains a first movement parameter, the first movement parameter corresponding to the first time axis information and being used to indicate a movement relationship between the first part and the second part.

S106, the first part sends the first time axis information and the first movement parameter to the second part through wireless communication.

S108, the second part receives the first time axis information and the first movement parameter sent by the first part.

S110, the second part determines second time axis information corresponding to the first movement parameter in a local second time axis.

S112, the second part adjusts the second time axis based on the first time axis information and the second time axis information, such that the second time axis is synchronized with the first time axis.

As shown in FIG. 2, the first part and the second part respectively maintain a time axis locally, and the time axis may be composed of a plurality of different times. In addition, the embodiments of the present disclosure is built based on the fixed difference between the movement parameters of the first part and the second part when they move to a certain physical position (in some implementation scenarios, the difference may be fixed to 0). Therefore, while maintaining their respective time axes, the first part and the second part may also need to record the movement parameters corresponding to each time (or a part of the time).

That is, the first part and the second part may respectively maintain the correspondence between the local time axis and the movement parameter. In some embodiments, the first part may maintain the correspondence between the first time axis and the first movement parameter, and the second part may maintain the correspondence between the second time axis and the second movement parameter. It should be noted that the first movement parameter and the second movement parameter may be the same type or the same type of parameters. That is, if the first movement parameter is a relative rotation angle, the second movement parameter may also be a relative rotation angle.

It should be noted that that in the embodiments of the present disclosure, the term “first,” “second,” etc. are not used to limited the number of an item, but to distinguish the time axis and the like. It can be understood that in actual implementation scenarios, the first time axis may also be referred to as the second time axis, and the second time axis may also be referred to as the first time axis.

In the embodiments of the present disclosure, the movement parameter can be used to identify the movement relationship between the first part and the second part. In the specific maintenance of the time axes and the movement parameters, the specific type of parameter related to the connection method and the relative movement method of the first part and the second part may be recorded, which can include, but is not limited to the following two branches.

In the first branch, if the first part and the second part can rotation relatively, the first movement parameter may include an absolute angle of rotation.

In one possible design, both the first part and the second part may rotate, and the rotation axis of both may be the same. However, the rotation speed or rotation acceleration of the two may be different, resulting in the relative rotation of the first part and the second part.

At this time, when the first part and the second part rotate to the same physical position at the same time, the rotation axis of the two may be the same, and the absolute angle of rotation of the two may be the same. At this time, the difference between the two time axes may be determined based on the first time axis time and the second time axis time corresponding to the rotation angle, thereby realizing the synchronization of the first time axis and the second time axis.

Alternatively, in another possible design, the first part may not rotate and its position can be relatively fixed, while the second part may rotate. At this time, the second part may be rotatable relative to the first part. For example, the first part may be a stator and the second part may be a rotor.

At this time, the first movement parameter recorded by the first part may be the absolute angle of rotation of the second part around the axis of rotation. Similarly, the second movement parameter recorded by the second part may also be the absolute angle of rotation of the second part around the same axis of rotation. That is, the first movement parameter and the second movement parameter may have the same physical meaning, but the first time axis and the second time axis corresponding to the two may be different. Therefore, when the two rotate to the same angle at the same time, the difference between the two time axes may be determined by the corresponding relationship with the first time axis and the second time axis. Further, the second time axis may be adjusted to synchronize the first time axis with the second time axis.

In any of the foregoing designs, the range of the relative rotation angle of the first part and the second part may be greater than or equal to 360°, or less than 360°. The rotatable range may also affect the relative movement of the first part and the second part.

In some embodiments, if the relative rotation angle of the second part relative to the first part is greater than or equal to 360°, the rotation range of the second part relative to the first part may be circular. When the second part rotates, it may be rotated in a single direction relative to the first part, or it may be rotated in a variable direction relative to the first part. In addition, the second part may rotate continuously or intermittently. More specifically, the second part may continuously rotate relative to the first part in a first predetermined direction, or the second part may rotate intermittently relative to the first part. If the second part rotates intermittently, it may rotate in the first predetermined direction (e.g., a counterclockwise direction or a clockwise direction) each time, or each rotation method may be different. For example, the directions of any two adjacent intermittent rotations may be different.

Alternatively, if the relative rotation angle of the second part relative to the first part is less than 360°, the rotation range of the second part relative to the first part may be fan-shaped. At this time, the relative rotation method that can be achieved may include the second part reciprocating relative to the first part.

In addition to the aforementioned absolute value of rotation, the synchronization of the first time axis and the second time axis may also be achieved by using at least one of the following movement parameters of a relative rotation angle, a rotation speed, and a rotation acceleration as auxiliary parameters.

In the second branch, if the first part and the second part can slide relatively, the first movement parameter may include an absolute sliding distance.

Similar to the relative movement of the aforementioned rotation, in the embodiments of the present disclosure, the first part and the second part may slide and the sliding method (any one of distance, frequency, or direction) may be inconsistent to achieve relative sliding, or the position of the first part may be fixed, and the second part may slide relative to the first part.

In addition, in this implementation scenario, the implementation of the relative sliding of the first part and the second part may include, but is not limited to, the second part reciprocating relative to the first part. At this time, the second part may reciprocate relative to the first part in two directions. Alternatively, the second part may slide in a second predetermined direction relative to the first part. At this time, the movement direction of the second predetermined direction may be a single direction and pre-settable.

In addition to the aforementioned absolute sliding distance, at least one of the following movement parameters of a sliding relative distance, a sliding speed, and a sliding acceleration may be used as the auxiliary parameter to achieve synchronization between the first time axis and the second time axis.

Based on the aforementioned designs, regardless of the relative movement between the first part and the second part, the first movement parameter (obtained by the first part) and the second movement parameter (obtained by the second part) may be used to indicate the relative movement between the first part and the second part. When the first part and the second part move to the same position at the same time, the difference between their movement parameters may be fixed (in some scenarios, the difference may be the same). Therefore, it may be used as a bridge to synchronize the first time axis and the second time axis.

In addition, the embodiments of the present disclosure further provide the acquisition method of the aforementioned movement parameters, in which the first movement parameter may be obtained by sensing by a first sensor disposed on the first part, and the second movement parameter may be obtained by sensing by a second sensor disposed on the second part.

Functionally, the sensor types involves in the embodiments of the present disclosure may include, but are not limited to at least one of the angle sensors, distance sensors, speed sensors, and acceleration sensors. In some embodiments, the angle sensor may be used to acquire and obtain the rotation angle (the relative angle or the absolute angle is related to the zero position, which will be described in the following description), which may be specifically expressed as a grating angle sensor, a Hall angle sensor, etc.

In addition, the aforementioned functional sensors may have different forms during specific implementations, which may include, but is not limited to at least one of the potential sensors, photoelectric sensors, electromagnetic sensors, and force sensors.

It should be noted that although the embodiments of the present disclosure restrict the first movement parameter and the second movement parameter to be the same type of data, there is no particular limitation on whether the sensors used to acquire these data are the same. For example, if the first movement parameter and the second movement parameter are absolute rotation angles, the first part may use the Hall angle sensor disposed thereon to realize the acquisition of the first movement parameter, and the second part may use the grating angle sensor disposed thereon to realize the acquisition of the second movement parameter. In another example, both the first part and the second part may use the Hall angle sensors to realize the acquisition of the absolute rotation angles.

Based on the foregoing description of the movement parameters, for ease of description, the time synchronization method described in this technical solution will be described in detail by taking the first movement parameter as the absolute angle of rotation as an example.

In an embodiment of the present disclosure, when the first part and the second part move to the same physical position at the same time, the relationship between the first movement parameter and the second movement parameter recorded by the first part and the second part may be used to realize time synchronization.

In the embodiments of the present disclosure, the first time axis information may be one or more first times, and the second time axis information may be a second time. A first movement parameter may correspond to a first time, and a second movement parameter may correspond to a second time. Based on the relationship between the first movement parameter and the second movement parameter, the second movement parameter corresponding to the first movement parameter may be determined. In this way, the first time (first time axis information) and the second time (second time axis information) may be obtained, and then the synchronization adjustment of the second time axis may be performed.

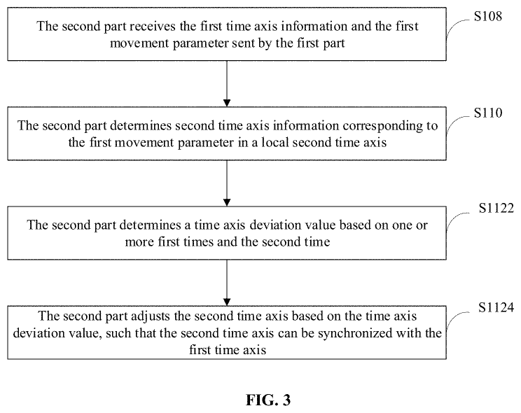

Referring to FIG. 3, which illustrates a method of synchronizing the time axis.

S1122, the second part determines a time axis deviation value based on one or more first times and the second time.

S1124, the second part adjusts the second time axis based on the time axis deviation value, such that the second time axis can be synchronized with the first time axis.

In some embodiments, the time axis deviation value may include a positive or a negative sign, where the sign is used to represent the relative time relationship between the first time axis and the second time axis.

For example, during one implementation, the positive sign may be used to indicate that the first time axis is more advanced than to the second time axis. At this time, it is needed to add a specific value (it may be regarded as an absolute value) of the time axis deviation value on the basis of the current time to realize the synchronization of the time axes. Conversely, the negative sign may be used to indicate that the first time axis later than the second time axis. At this time, it is needed to subtract a specific value (which may be regarded as an absolute value) of the time axis deviation value from on the basis of the current time to realize the synchronization of the time axes. Conversely, the definition still holds, which will be not repeated here.

In the present disclosure, when the first part sends the first time axis information to the second part, all times on the entire time axis may be sent to the second part as the first time axis information. Alternatively, it is also possible to send a part of the times in the first time axis as the first time axis information to the second part, where the part of the times may also be one time or a plurality of times.

In one possible design, considering that the purpose of the embodiments of the present disclosure is to synchronize the first time axis with the second time axis, therefore, one or more times closer to the current in the time series relationship may have more reference value for adjusting the time axes to synchronize. That is, more convenient to shorten the difference between the two time axes at the current time. Therefore, in a specific implementation, the first part may send one or more times closer to the current time as the first time axis information to the second part.

In contrast, as the basis for the second part to adjust the local second time axis, the first time closer to the current time may be more valuable. As such, when the second part specifically performs the process of adjusting the second time axis, it may be implemented based on the first time closer to the current time.

At this time, if the second part receives a plurality of first times, the second part may determine a target first time among the plurality of first times based on the current time, where the target first time may be the first time closest to the current time. Further, the second part may determine a time axis deviation value based on the target first time and the second time, and a target first movement parameter corresponding to the target first time may be the target first movement parameter.

It should be noted that when the first part sends the first time axis information to the second part, it may also need to send one or more first movement parameters corresponding to these times. However, in the embodiments of the present disclosure, there is not limitation on the number of first time axis information and the first movement parameters sent by the first part to the second part in one transmission. The numbers of the first time axis information and the first movement parameters may not be the same, but the number of each piece of data sent may be at least one.

At this time, when determining the target first time described above, there may be an exception in which the first movement parameter corresponding to the time closest to the current time may not be sent to the second part. At this time, the time closest to the current time with the corresponding sent first movement parameter may be acquired and used as the target first time.

For example, the first part may send two pieces of the first time axis information in one transmission, including a time A, a time B (closer to the current time), and the first movement parameter x (corresponding to the time A). After receiving this information, the second part may determine that time A is closer to the current time and includes the corresponding first movement parameter x, thereby determining time A as the target first time, and the first movement parameter x as the target first movement parameter.

Based on the foregoing process, the second part may determine the target first time and the target first movement parameter in the information sent by the first part, subsequently, the corresponding second movement parameter may need to be determined. For the determination method, reference may be made to FIG. 4, which includes the following processes.

S1102, the second part obtains a second movement parameter corresponding to the first movement parameter.

S1104, the second part obtains the second time corresponding to the second movement parameter as the second time axis information based on a first correspondence.

In some embodiments, the first correspondence may be a correspondence between each time in the second time axis information and the second movement parameters. That is, the process of maintaining the correspondence between the second time axis and the second movement parameter by the second part described above. When it is implemented, it may be expressed as the second part obtaining the second movement parameter at each time in the second time axis, which will not be described in detail here.

In some embodiments, obtaining the second movement parameter corresponding to the first movement parameter may include the following two processing methods.

In the first processing method, considering that there may be a fixed difference between the absolute angles of rotation of the first part and the second part. At this time, the angle difference between the first part and the second part moving to the same physical position at the same time may be fixed. Therefore, when performing time synchronization, the fixed angle difference may need to be combined to achieve synchronization.

More specifically, the second part may add or subtract the angle difference on the basis of the first movement parameter (if multiple first movement parameters are sent, this may be the target first movement parameter) to obtain the corresponding second movement parameter. Subsequently, based on the correspondence between the second movement parameter recorded by the second part and the time in the second coordinate axis, the target second time corresponding to the second movement parameter may be determined, and the target second time may be used as the second time axis information corresponding to the first movement parameter.

For example, if the difference between the first rotation angle recorded by the first part and the second rotation angle recorded by the second part is +10° when rotating to the same fixed position at the same time, then, the first part may send two pieces of information of a time A1 and a corresponding 50° to the second part through wireless communication. After receiving the information, the second part may determine that the second absolute angle of rotation corresponding to the 50° at this time is 50+10=60°. Then the second part may determine that the time corresponding to the 60 in the second time axis is a time A2 based on the correspondence between the second absolute rotation angle maintained by itself and the second time axis, in fact, the time A1 and the time A2 should be the same. Based on this, the time axis deviation value between A1 and A2 may be obtained, and the second time axis may be adjusted such that the first time axis can be synchronized with the second time axis.

In the second processing method, in another possible design, in order to save the amount of data processing or improve the synchronization efficiency, the movement parameters of the first part and the second part may be zero-calibrated in advance, such that the different between the absolute rotate angles recorded by the first part and the second part is 0. At this time, when the first part and the second part move to the same physical position at the same time, the first movement parameter and the second movement parameter respectively recorded by the first part and the second part may be the same, which is more convenient for the subsequent synchronization processing.

In a specific processing process, before the first part and the second part obtain the movement parameters respectively, the method may further include the process of the first part performing zero point calibration on the rotation angle, such that the zero rotation point of the first time axis and the zero rotation point of the second time axis may correspond to the same physical position.

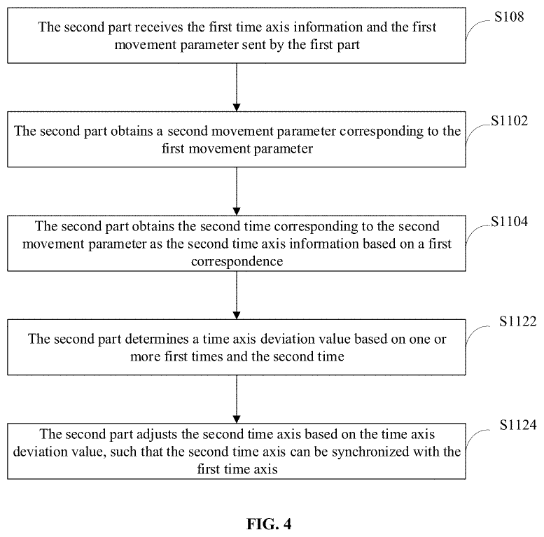

Alternatively, as shown in FIG. 5, the method may further include a process S109, the second part performing zero point calibration on the absolute rotation angle, such that the zero rotation point of the second time axis and the zero rotation point of the first time axis may correspond to the same physical position.

One of the foregoing processes may be performed. That is, considering that the zero point calibration process can be realized only by the processing of one of the parts, for the sake of saving resource, only process can be executed instead.

More specifically, the zero point calibration described in the embodiments of the present disclosure may refer to aligning the zero point where the first part records the first absolute angle of rotation and the zero point where the second part records the second absolute angle of rotation, such that both can have the same coordinate zero point.

After the foregoing processing, the second part receives the first movement parameter sent by the first part, and there may be no need to perform addition and subtraction processing. The first movement parameter may be directly used as the second movement parameter, and the second time axis information may be determined in the second time axis. Compared with the foregoing process, this can simplify the data processing process and effectively improve the synchronization efficiency.

In addition, the foregoing processes are all based on the fact that the first part and the second part use the same rotating coordinate system for processing, which can simplify the conversion process of the coordinate system. It can be understood that in an actual application scenario, if the first part records the first movement parameter using a first rotating coordinate system, the second part records the second movement parameter using a second rotating coordinate system, and the first rotating coordinate system is different from the second rotating coordinate system, a correspondence between the first rotating coordinate system and the second rotating coordinate system may need to be established before implementing the technical solutions. As such, after the second part receives the first movement parameter sent by the first part, the corresponding second movement parameter may be determined based on the correspondence, and the ne the second time axis information may be determined.

In addition, considering that the relative movement of the first part and the second part is rotation and the range of the rotation angle is greater than 360°, when the second movement parameter corresponding to the first movement parameter is obtained, it may be needed to consider the influence of the number of rotations. At this point, there are two processing methods that can be used.

In the first processing method, when the first part and the second part maintain the correspondence between their respective movement parameters and the local time axes, the number of rotation may be recorded as an attribute of the movement parameter. In this way, after the second part receives the first movement parameter, it may determine the second movement parameter with the same rotation attribute, thereby avoiding repeated angle values under different rotations, and avoiding disadvantages for time synchronization,

For example, when performing a specific processing, the received first absolute rotation angle may be compared with the current second absolute rotation angle to determine whether the current second absolute rotation angle has entered the next circle relative to the first absolute rotation angle. If so, it may be needed to determine the target second absolute rotation angle from the second absolute rotation angle recorded in the previous rotation.

In the second processing method, the time interval between the first part sending the first time axis information to the second part and the first movement parameter may be less than the time it takes for the second part to rotate one circle. In this way, it is also possible to avoid repeated angle values at different numbers of rotations.

For example, if the second part rotates at a rate of 15 Hz relative to the first part, the time interval for sending the first time axis information and the first movement parameter to the first part may be 66.7 ms.

In addition, the second part and the first part may exchange information through wireless communication. Therefore, before performing the aforementioned process at S106, a wireless communication connection between the first part and the second part may need to be established. Therefore, when performing the aforementioned process at S106, the first part may send the first time axis information and the first movement parameter to the first part through wireless communication.

The wireless communication methods involved in the embodiments of the present disclosure may include, but are not limited to, Bluetooth communication, wireless-fidelity (Wi-Fi) communication, or radio frequency identification (RFID) communication. Other methods that can implement wireless communication technologies are acceptable, and the embodiments of the present disclosure are not particularly limited.

As described above, the technical solutions provided in the embodiments of the present disclosure can realize time synchronization in a time synchronization system. At this time, the first time axis information can be the first time axis information locally of the first part. In addition, the technical solutions provided in the embodiments of the present disclosure can also realize the time synchronization between the time synchronization system and the external device. At this time, the first time axis information may be third time axis information of the external device received by the first part through a data interface.

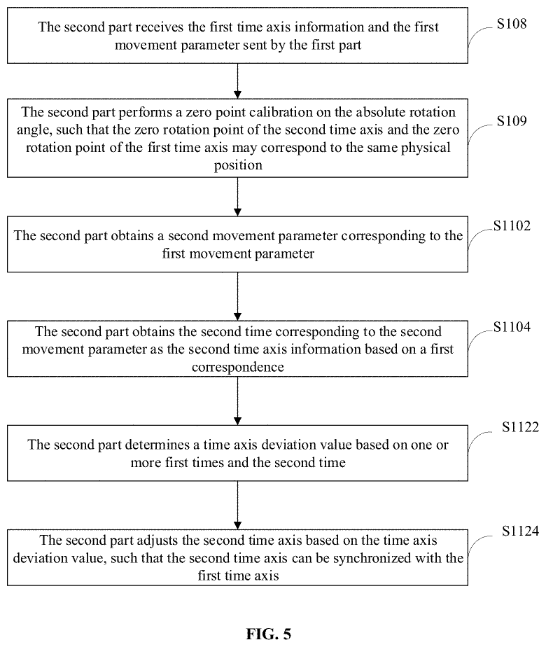

At this time, referring to FIG. 6, a specific implementation of the process at S102 may include the following.

S101, the external device sends a synchronization signal to the first part through the data interface, the synchronization signal carrying the information of the third axis.

S1022, the first part receives the synchronization signal sent by the external device through the data interface and uses the third time axis information carried by the synchronization signal as the first time axis information.

More specifically, the first part may be connected to an external device through a data interface disposed thereon, such as a data input/output interface, and the two may exchange information through a wired connection. The time delay of this wired communication method may be relatively small, and may have less impact on time synchronization than the time delay caused by the wireless communication in conventional technology.

In this implementation, after the first part receives the first time axis information sent by the external device, the first part may immediately obtain the corresponding first movement parameter and send it to the second part. In this way, the second part may realize time synchronization with the external device based on the information sent by the first part.

The first part may also maintain and adjust the local first time axis based on the first time axis information, such that the first time axis may be synchronized with the third time axis, thereby realizing the synchronization of the first time axis, the second time axis, and the third time axis. That is, realizing the synchronization between the time synchronization system and the external device.

In some embodiments, the synchronization signal sent by the external device may be a synchronization pulse signal, and the synchronization pulse signal may include at least one pulse bump, and the first time axis information may be carried at the pulse bump.

In a possible design, each pulse bump may carry a third time axis time (in this case, as the first time axis information). This time may be the sending time of the external device sending the pulse bump. In this way, when a first device maintains the correspondence between the first time axis and the first movement parameter, the first movement parameter may be acquired at the time when the pulse bump is received, and the correspondence may be obtained by recording.

Further, when the technical solution is implemented in this method, the first part may immediately send the pulse bump and the corresponding first movement parameter to the second part after receiving the pulse bump and the corresponding first movement parameter. In a specific sending process, the time of the current pulse bump and the first movement parameter may be sent separately, or one or more times before the pulse bump and the corresponding one or more first movement parameters may also be sent to the second part. The processing method of the second part is as described above and will not be repeated.

Alternatively, in another implementation scenario, after the first part receives the information of the third time axis, it may not directly forward it to the second part, but may select one or more of the times as the first time axis information and send it to the second part.

At this time, the first part may obtain a target time and a target first movement parameter corresponding to the target time based on the first time axis information. In some embodiments, the target time may be a first time closest to the current time in the first time axis. Subsequently, the first part may send the target time and the target first movement parameter to the second part.

In addition, in this implementation scenario, since the first time axis information is obtained based on the third time axis information of the external device, in order to further synchronize the first coordinate axis and the third coordinate axis, the method may further include the process of the first part adjusting the local first time axis based on the first time information, such that the first time axis can be synchronized with the third time axis. The adjustment method may be the same as the method in which the second part synchronizes the first coordinate axis and the second coordinate axis, and will not be repeated.

In addition, the external device in the embodiments of the present disclosure is not specifically limited, as long as it can interact with the first part in the aforementioned wired communication method for information exchange.

In one possible implementation scenario, the time synchronization system may be a motor system, where the first part may be a stator of the motor, and the second part may be a rotor of the motor. The motor system may be mounted in any device.

In this implementation scenario, the second part may also include a signal receiving device and/or a signal transmitting device of the sensor, and the first part may also include a controller of the sensor.

In another possible implementation scenario, the motor system may be disposed in the radar system of an unmanned aerial vehicle, and the aforementioned external device may be the internal or external control device of the radar system, such as a flight control device. In this implementation scenario, the flight control device, the rotor and the stator in the radar may synchronize the time axis, which is of great significance to the flight control of the unmanned aerial vehicle, and can improve the safety and stability of the unmanned aerial vehicle to a certain extent.

In some embodiments, the time synchronization system may include, but is not limited to at least one of a microwave radar system, a laser radar system, an ultrasonic system, and a gimbal system.

It can be understood that some or all of the processes or operations in the above-mentioned embodiments are merely example, and the embodiments of the present disclosure may also perform other operations or variations of the operations. In addition, the various processes may be performed in a different order presented in the foregoing embodiments, and it may not be necessary to perform all operations in the foregoing embodiments.

It can be appreciated by those skilled in the art that part or all of the processes of a method consistent with the disclosure can be implemented in the form of computer program stored in a non-transitory computer-readable storage medium, which can be sold or used as a stand-alone product. The computer program can include instructions that enable a computer device, such as a processor, a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

In addition, based on the time synchronization method described in the foregoing embodiments, an embodiment of the present disclosure further provides an embodiment of a device for implementing each process and method in the foregoing method embodiment.

First, the embodiment of the present disclosure provides a time synchronization device. The time synchronization device may be disposed in a second part, and the time synchronization system may include a first part and the second part. The first part and the second part may be mechanically connected, and the first part and the second part may move relative to each other. Further, the first part and the second part may be connected through wireless communication.

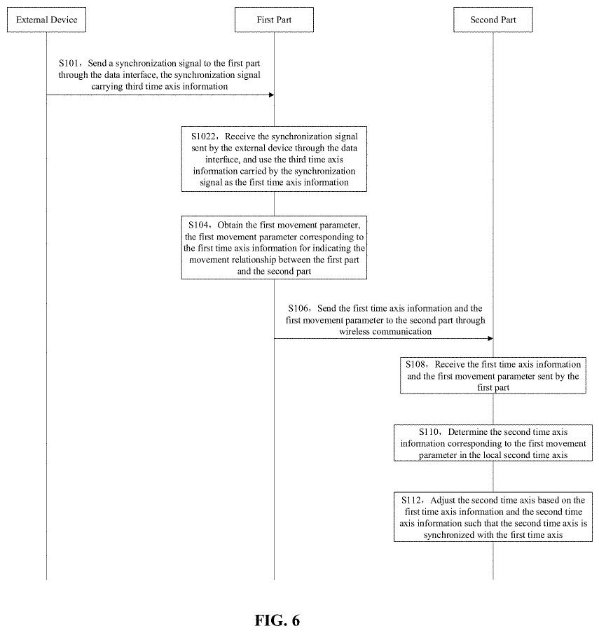

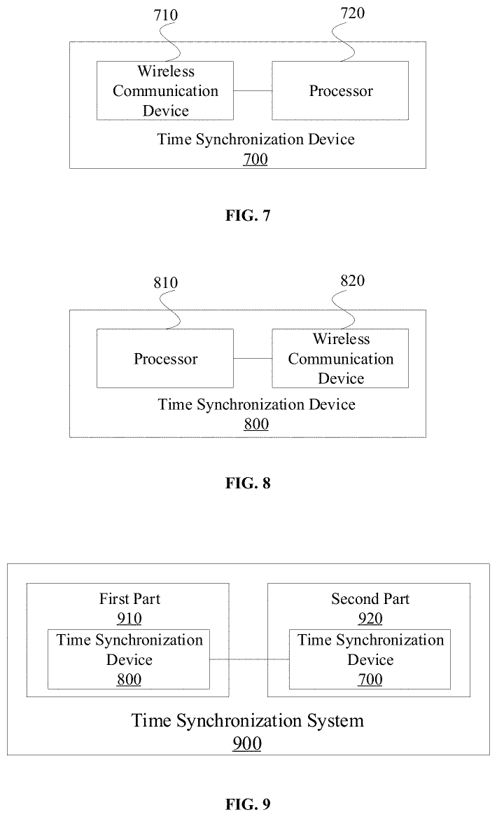

Referring the FIG. 7, a time synchronization device 700 includes a wireless communication device 700 configured to receive the first time axis information and the first movement parameter sent by the first part, the first movement parameter corresponding to the first time axis information and may be used to indicate the movement relation between the first part and the second part; and a processor 720 configured to determine the second time axis information corresponding to the first movement parameter in the local second time axis. Further, the processor 720 may be configured to adjust the second time axis based on the first time axis information and the second time axis information, such that the second time axis may be synchronized with the first time axis.

In one possible design, the second part may rotate relative to the first part, and the first movement parameter may include an absolute angle of rotation.

In some embodiments, in one design, the relative angle of rotation of the second part relative to the first part may be greater than or equal to 360°. At this time, the second part may continuously rotate in the first predetermined direction relative to the first part, or the second part may rotate intermittently relative to the first part.

In another design, the relative angle of rotation of the second part relative to the first part may be less than 360°. At this time, the second part may reciprocate relative to the first part.

In addition, the first movement parameter may include at least one of a relative angle of rotation, a rotation speed, and a rotation acceleration.

In another possible design, the first part and the first part may slide relatively, and the first movement parameter may include an absolute sliding distance. At this time, the first part may reciprocate relative to the first part, or the second part may slide in the second predetermined direction relative to the first part.

In addition, the first movement parameter may also include at least one of a relative sliding distance, a sliding speed, and a sliding acceleration.

In the embodiments of the present disclosure, the first movement parameter may be sensed by a first motion sensor disposed on the first part.

In some embodiments, the first motion sensor may include at least one of an angle sensor, a distance sensor, a speed sensor, and an acceleration sensor.

In some embodiments, the first motion sensor may include at least one of a potential sensor, a photoelectric sensor, an electromagnetic sensor, and a force sensor.

In one possible design, the processor 720 may be further configured to perform zero point calibration on the absolute angle of rotation in the local second time axis before determining the second time axis information corresponding to the first movement parameter, such that the zero point of rotation of the second time axis and the zero point of rotation of the first time axis may correspond to the same physical position

In another possible design, the first time axis information may be the time axis information of an external device received by the first part through the data interface.

In another possible design, the first time axis information may be one or more first times, and the second time axis information may be the second time.

In another possible design, the processor 720 may be further configured to determine the time axis deviation value based on the one or more first times and the second time; adjust the second time axis based on the time axis deviation value, such that the second time axis may be synchronized with the first time axis.

In another possible design, the processor 720 may be further configured to determine the target first time in the plurality of first times based on the current time, where the target first time may be the first time closest to the current time; and determine the time axis deviation value based on the target first time and the second time.

In another possible design, the processor 720 may be further configured to record the first correspondence in the local second time axis before determining the second time axis information corresponding to the first movement parameter, the first correspondence being a correspondence between each time in the second time axis and the second movement parameter.

In another possible design, the processor 720 may be further configured to obtain the second movement parameter corresponding to the first movement parameter; and obtain the second time corresponding to the second movement parameter as the second time axis information based on the first correspondence.

In another possible design, the processor 720 may be further configured to obtain the second movement parameter at each time in the second time axis.

In the embodiments of the present disclosure, the second movement parameter may be sensed by a second motion sensor disposed on the second part.

In some embodiments, the second motion sensor may include at least one of an angle sensor, a distance sensor, a speed sensor, and an acceleration sensor.

In some embodiments, the second motion sensor may include at least one of a potential sensor, a photoelectric sensor, an electromagnetic sensor, and a force sensor.

In one possible design, the time synchronization the first part may be a stator of the motor, and the second part may be a rotor of the motor.

In another possible design, the second part may include a signal receiving device and/or a signal transmitting device of the sensor, and the first part may include a controller of the sensor.

In another possible design, the time synchronization system may include, but is not limited to at least one of a microwave radar system, a laser radar system, an ultrasonic system, and a gimbal system.

Next, an embodiment of the present disclosure further provides a time synchronization device. The time synchronization device may be disposed in a first part, and the time synchronization system may include the first part and a second part. The first part and the second part may be mechanically connected, and the first part and the second part may move relative to each other. Further, the first part and the second part may be connected through wireless communication.

Referring the FIG. 8, a time synchronization device 800 includes a processor 810 configured to obtain the first time axis information. The processor 810 may be further configured to obtain the first movement parameter. The first movement parameter may correspond to the first time axis information and may be used to indicate the movement relationship between the first part and the second part. The time synchronization device further includes a wireless communication device 820 configured to send the first time axis information and the first movement parameter to the second part through wireless communication.

In one possible design, the second part may rotate relative to the first part, and the first movement parameter may include an absolute angle of rotation.

In some embodiments, the relative angle of rotation of the second part relative to the first part may be greater than or equal to 360°. At this time, the second part may continuously rotate in the first predetermined direction relative to the first part, or the second part may rotate intermittently relative to the first part.

In another design, the relative angle of rotation of the second part relative to the first part may be less than 360°. At this time, the second part may reciprocate relative to the first part.

In addition, the first movement parameter may include at least one of a relative angle of rotation, a rotation speed, and a rotation acceleration.

In another possible design, the first part and the first part may slide relatively, and the first movement parameter may include an absolute sliding distance. At this time, the first part may reciprocate relative to the first part, or the second part may slide in the second predetermined direction relative to the first part.

In addition, the first movement parameter may also include at least one of a relative sliding distance, a sliding speed, and a sliding acceleration.

In the embodiments of the present disclosure, the first movement parameter may be sensed by a first motion sensor disposed on the first part.

In some embodiments, the first motion sensor may include at least one of an angle sensor, a distance sensor, a speed sensor, and an acceleration sensor.

In some embodiments, the first motion sensor may include at least one of a potential sensor, a photoelectric sensor, an electromagnetic sensor, and a force sensor.

In one possible design, the processor 810 may be further configured to perform zero point calibration on the angle of rotation before obtain the first movement parameter, such that the zero point of rotation of the second time axis and the zero point of rotation of the first time axis may correspond to the same physical position.

In another possible design, the processor 810 may be further configured to receive the synchronization signal sent by the external device through the data interface, and use the second time axis information carried by the synchronization signal as the first time axis information.

In another possible design, the synchronization signal may be a synchronization pulse signal. The synchronization pulse signal may include at least one pulse bump, and the pulse bump may carry the first time axis information.

In another possible design, each pulse bump may carry a time, which may be the sending time of the pulse bump sent by the external device.

In another possible design, the processor 810 may be configured to obtain the first movement parameter at the time when the pulse bump is received.

In another possible design, the processor 810 may be further configured to obtain the target time and the target first movement parameter corresponding to the target time based on the first time axis information. In some embodiments, the target time may be the first time closest to the current time in the first time axis. In some embodiments, the wireless communication device 820 may also be configured to send the target time and the target first movement parameter to the second part.

In another possible design, the processor 810 may be further configured to adjust the local first time axis based on the first time axis information such that the first time axis may be synchronized with the third time axis.

In another possible design, the wireless communication device 820 may be configured to send the first time axis information and the first movement parameter to the second part through wireless communication.

In one possible design, the time synchronization the first part may be a stator of the motor, and the second part may be a rotor of the motor.

In another possible design, the second part may include a signal receiving device and/or a signal transmitting device of the sensor, and the first part may include a controller of the sensor.

In another possible design, the time synchronization system may include, but is not limited to at least one of a microwave radar system, a laser radar system, an ultrasonic system, and a gimbal system.

Further, an embodiment of the present disclosure provides a time synchronization system. Referring to FIG. 9, a time synchronization system 900 includes a first part 910 provided with the aforementioned time synchronization device 800; and a second part 920 provided with the aforementioned time synchronization device 700.

In some embodiments, an embodiment of the present disclosure provides a readable storage medium with a computer program stored thereon. The computer program can be executed by a controller to implement the time synchronization method executed on the first part side in any of the previous embodiments.

In some embodiments, an embodiment of the present disclosure provides a readable storage medium with a computer program stored thereon. The computer program can be executed by a controller to implement the time synchronization method executed on the second part side in any of the previous embodiments.

Other embodiments will be apparent to those skilled in the art from consideration of the specification and practice of the disclosure here. This present disclosure is intended to cover any variations, uses, or adaptations of the present disclosure following the general principles thereof and including common knowledge or conventional technical means in the field that are not disclosed in the present disclosure. The specification and examples be considered as exemplary only, and the true scope and spirit of the present disclosure are indicated by the following claims.

It should be understood that the present disclosure is not limited to the exact construction that has been described above and illustrated in the accompanying drawings, and that various modifications and changes can be made without departing from the scope thereof. The scope of the present disclosure is only limited by the appended claims.

Finally, it should be noted that the foregoing embodiments are merely intended for describing the technical solutions of the present disclosure, but not to limit the present disclosure. Although the present disclosure is described in detail with reference to the foregoing embodiments, it should be understood by those of ordinary skill in the art that the technical solutions described in the foregoing embodiments may still be modified, or a part or all of the technical features may be equivalently replaced without departing from the spirit and scope of the present disclosure. As a result, these modifications or replacements do not make the essence of the corresponding technical solutions depart from the scope of the technical solutions of the present disclosure.

What is claimed is:

1. A time synchronization method for a time synchronization system including a first part and a second part, the first part being mechanically connected to the second part, the first part being movable relative to the second part, and the first part being connected to the second part through a wireless communication; and the method comprising:
the second part receiving first time axis information and a first movement parameter sent by the first part, the first movement parameter corresponding to the first time axis information for indicating a movement relationship between the first part and the second part;
the second part determining second time axis information corresponding to the first movement parameter in a local second time axis; and
the second part adjusting the second time axis based on the first time axis information and the second time axis information such that the second time axis is synchronized with the first time axis.

2. The method of claim 1, wherein:
the second part and the first part are configured to rotate relative to each other, and the first movement parameter includes an absolute angle of rotation.

3. The method of claim 2, wherein:
a relative angle of rotation of the second part relative to the first part is greater than or equal to 360°, and
the second part is configured to continuously rotate in a first predetermined direction relative to the first part, or the second part is configured to rotate intermittently relative to the first part.

4. The method of claim 2, wherein:
the relative angle of rotation of the second part relative to the first part is less than 360°, and
the second part is configured to reciprocate relative to the first part.

5. The method of claim 2, wherein:
the first movement parameter further includes at least one of a relative angle of rotation, a rotation speed, and a rotation acceleration.

6. The method of claim 1, wherein:
the second part and the first part are configured to slide relative to each other, and the first movement parameter includes an absolute sliding distance.

7. The method of claim 6, wherein:
the second part is configured to reciprocate relative to the first part, or
the second part is configured to slide in a second predetermined direction relative to the first part.

8. The method of claim 6, wherein:
the first movement parameter further includes at least one of a relative sliding distance, a sliding speed, and a sliding acceleration.

9. The method of claim 1, wherein:
the first movement parameter is sensed by a first motion sensor disposed on the first part.

10. The method of claim 9, wherein:
the first motion sensor includes at least one of an angle sensor, a distance sensor, a speed sensor, an acceleration sensor, a potential sensor, a photoelectric sensor, an electromagnetic sensor, or a force sensor.

11. The method of claim 2, wherein before the second part determining the second time axis information corresponding to the first movement parameter in the local second time axis, further comprising:
the second part performing a zero point calibration on the absolute angle of rotation such that a zero rotation point of the second time axis and a zero rotation point of the first time axis correspond to a same physical position.

12. The method of claim 1, wherein:
the first time axis information is the time axis information of an external device received by the first part through a data interface,
the first time axis information includes one or more first times, and
the second time axis information includes a second time.

13. The method of claim 12, wherein the second part adjusting the second time axis based on the first time axis information and the second time axis information such that the second time axis is synchronized with the first time axis includes:
the second part determining a time axis deviation value based on the one or more first times and the second time; and
the second part adjusting the second time axis based on the time axis deviation value such that the second time axis is synchronized with the first time axis.

14. The method of claim 13, wherein the second part determining the time axis deviation value based on the plurality of first times and the second time includes:
the second part determining a target first time in the plurality of first times based on a current time, the target first time being a first time closest to the current time; and
the second part determining the time axis deviation value based on the target first time and the second time.

15. The method of claim 1, wherein before the second part determining the second time axis information corresponding to the first movement parameter in the local second time axis, further comprising:
the second part recording a first correspondence, the correspondence being a correspondence between each time in the second time axis and a second movement parameter.

16. The method of claim 15, wherein the second part determining the second time axis information corresponding to the first movement parameter in the local second time axis includes:
the second part obtaining the second movement parameter corresponding to the first movement parameter; and
the second part obtaining the second time corresponding to the second movement parameter based on the first correspondence as the second time axis information.

17. The method of claim 15, wherein the second part recording the first correspondence includes:
the second part obtaining the second movement parameter at each time in the second time axis.

18. The method of claim 15, wherein:
the second movement parameter is sensed by a second motion sensor disposed on the second part.

19. The method of claim 18, wherein:
the second motion sensor includes at least one of an angle sensor, a distance sensor, a speed sensor, and an acceleration sensor, a potential sensor, a photoelectric sensor, an electromagnetic sensor, or a force sensor.

20. The method of claim 1, wherein:
the first part includes a stator of a motor, and the second part includes a rotor of the motor,
the second part includes a signal receiving device and/or a signal transmitting device of a sensor, and the first part includes a controller of the sensor, and
the time synchronization system includes at least one of a microwave radar system, a lidar system, an ultrasonic system, and a gimbal system.
